(19) United States
(12) Patent Application Publication
(10) Pub. No.: US 2024/0295995 A1
(43) Pub. Date: Sep. 5, 2024

(54) INFORMATION PROCESSING APPARATUS, INFORMATION PROCESSING METHOD CONTROL METHOD, AND STORAGE MEDIUM

(71) Applicant: CANON KABUSHIKI KAISHA, Tokyo (JP)

(72) Inventors: Yasuo Kurata, Kanagawa (JP); Shoichi Matsuda, Saitama (JP)

(21) Appl. No.: 18/581,591

(22) Filed: Feb. 20, 2024

(30) Foreign Application Priority Data
Mar. 3, 2023 (JP) 2023-032749
Sep. 21, 2023 (JP) 2023-156282
Nov. 24, 2023 (JP) 2023-199024

(51) Int. Cl. G06F 3/12; H04N 1/40; H04N 1/60

(52) U.S. Cl. CPC G06F 3/1205; G06F 3/1243; H04N 1/40012; H04N 1/6008

(57) ABSTRACT

The present disclosure is intended to improve usability related to print setting. An embodiment of the present disclosure is a non-transitory computer-readable storage medium storing one or more programs configured to cause one or more computers to function as: an obtaining unit configured to obtain type information indicating the type of a printing media on which printing is to be performed; and a display controlling unit configured to perform, even when no user instruction to use a past history at printing of a printing target is provided, control to display information as a content to be set to a particular setting item in accordance with the type information obtained by the obtaining unit on a print setting screen displayed based on an operation for printing the printing target, the information indicating print setting based on a setting history including contents of setting by a user at past printing.

### BACKGROUND

### Field

The present disclosure relates to an information processing apparatus configured to perform setting related to printing, an information processing method control method, and a storage medium.

### Description of the Related Art

Printing medium such as sheets used to form an image by a printer (that is, to perform printing) have various kinds and sizes. In a case where printing is performed by transmitting printing data to a printer from an information processing apparatus (for example, a PC) connected to the printer, a user sets the kind and size of a printing media through a setting screen (GUI) of a printer driver installed on the information processing apparatus.

However, it is cumbersome for the user to sequentially set setting items of print setting with consideration on sheets set to the printer. In a method of solving this problem, the printer holds information of the kind and size of a printing media that is set to a feeding unit of the printer. In this method, an information processing apparatus connected to the printer obtains, from the printer, information of the kind and size of the printing media that is set to the feeding unit of the printer and executes processing based on the obtained information.

Japanese Patent Laid-Open No. 2017-117026 discloses, as the above-described method, a method of obtaining, from a printer, information including information of the kind and size of a printing media that is set to a feeding unit of the printer, and reflecting the information onto print setting.

### SUMMARY

However, various setting items other than the kind and size of a printing media can be set in setting through a GUI of a printer driver but the setting differs depending on usage of a printed material desired by a user. Printed material usage that is different for each user is needed for the same printing media in some cases where, for example, a user desires to print a poster on ordinary paper whereas another user desires to print a CAD drawing on ordinary paper.

Thus, a user needs to perform print setting in accordance with desired printed material usage in each case, which makes an operation extremely cumbersome and leads to poor efficiency.

Thus, the present disclosure is made in view of the above-described problem and intended to improve usability related to print setting.

An embodiment of the present disclosure is a non-transitory computer-readable storage medium storing one or more programs configured to cause one or more computers to function as: an obtaining unit configured to obtain type information indicating the type of a printing media on which printing is to be performed; and a display controlling unit configured to perform, even when no user instruction to use a past history at printing of a printing target is provided, control to display information as a content to be set to a particular setting item in accordance with the type information obtained by the obtaining unit on a print setting screen displayed based on an operation for printing the printing target, the information indicating print setting based on a setting history including contents of setting by a user at past printing.

Further features of the present invention will become apparent from the following description of exemplary embodiments with reference to the attached drawings.

### BRIEF DESCRIPTION OF THE DRAWINGS

FIG. 1 is a block diagram illustrating the configuration of a printing system;

FIG. 2 is a block diagram illustrating the software configuration of a printer driver;

FIGS. 3A and 3B are each a diagram illustrating a dialog box that is a print setting screen for the printer driver;

FIG. 4 is a diagram illustrating a print purpose table;

FIG. 5 is a flowchart of processing (activation processing) when the print setting screen is opened;

FIG. 6 is a diagram illustrating sheet information;

FIGS. 7A to 7C are diagrams illustrating kind-specific setting history information according to a first embodiment;

FIG. 8 is a diagram illustrating a previous-value reflection message dialog box;

FIG. 9 is a flowchart of processing (closing processing) when the print setting screen is closed;

FIG. 10 is a diagram illustrating a dialog box displaying a check message related to history information update;

FIGS. 11A and 11B are diagrams illustrating the kind-specific setting history information according to a second embodiment;

FIGS. 12A to 12D are each a diagram illustrating a dialog box that is the print setting screen for the printer driver according to a third embodiment;

FIG. 13 is a flowchart of processing (closing processing) when the print setting screen is closed according to the third embodiment;

FIGS. 14A to 14D are diagrams illustrating the kind-specific setting history information according to the third embodiment; and

FIG. 15 is a flowchart of processing (activation processing) when the print setting screen is opened according to the third embodiment.

### DESCRIPTION OF THE EMBODIMENTS

### First Embodiment

Preferable embodiments of the present disclosure will be described below in detail with reference to the accompanying drawings. The embodiments described below are not intended to limit the present invention according to the claims beyond necessity, and not all combinations of characteristics described in the embodiments are necessarily essential as means for solution of the present disclosure.

### <System Configuration>

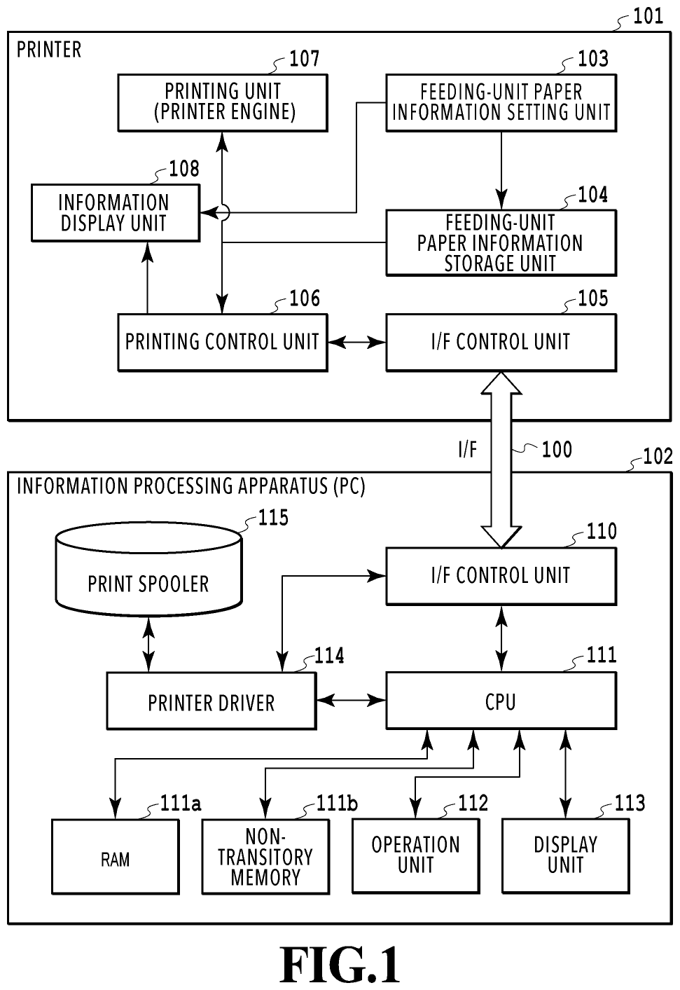

The configuration of a printing system according to the present embodiment will be described below with reference to FIG. 1. FIG. 1 is a block diagram of the printing system according to the present embodiment.

In FIG. 1, a printer 101 is a color printer configured to perform image formation by an ink jet scheme and forms an image based on printing data generated by a PC 102 to be described later. The printer 101 includes a plurality of feeding units. Roll paper can be attached (set) to each of the plurality of feeding units. In the present embodiment, a color printer of the ink jet scheme is employed as the printer 101, but the kind of a printer (also referred to as a printing apparatus) is not limited thereto.

An information processing apparatus 102 performs generation of printing data and control of the printer 101 connected thereto.

In this example, the information processing apparatus is assumed to be a personal computer (hereinafter referred to as a PC). The PC 102 has a function to receive user instructions and inputs related to print setting. Although not illustrated in FIG. 1, an operation system (OS) for controlling the PC 102 is incorporated in the PC 102, and various kinds of functional modules operate on the OS.

A communication interface 100 connects the PC 102 and the printer 101. In this example, the communication interface is assumed to be network connection, but may be USB or the like as well and may be any interface such as a wired or wireless interface with which bidirectional communication is achieved. In this manner, the printing system according to the present embodiment is not a single apparatus but has a configuration in which the PC 102 and the printer 101 are connected to each other through a particular bidirectional interface. However, the printing system is not limited to this configuration but may be an apparatus-integrated system having integrated functions of a PC and a printer. The following contents of the printer 101 and the PC 102, which are thought to be not particularly necessary for describing features of the present embodiment are omitted as appropriate.

An information display unit 108 performs display based on sheet information of each feeding unit, which is set by a feeding-unit sheet information setting unit 103 and printing information (for example, warning information) controlled by a printing control unit 106 to be described later. The information display unit 108 includes a display apparatus such as an LED.

The feeding-unit sheet information setting unit 103 is used to set sheet information of sheets that are set to the plurality of feeding units as part of a printing unit (printer engine) 107 to be described later. The feeding-unit sheet information setting unit 103 includes a means such as a button with which a user sets the sheet information. Alternatively, the sheet information may be read and set by using a sensor mounted on each feeding unit.

A feeding-unit sheet information storage unit 104 is achieved as a non-transitory storage apparatus. The feeding-unit sheet information storage unit 104 stores the sheet information of each feeding unit, which is set by the feeding-unit sheet information setting unit 103.

The printing control unit 106 receives printing data transmitted from the PC 102 and loads the printing data onto the printer engine. The printing data transmitted from the PC 102 is data already provided with image processing on the PC 102 side based on print setting including the kind and size of a printing media, and in this example, the printer engine is controlled in accordance with a printing control command included in the printing data.

Data including printing binary data (intermediate data yet to be binarized, in some cases) and various kinds of commands for controlling the amount of ink application, the number of passes, the printing direction, and the amount of sheet conveyance is used as specific printing data. Alternatively, typical printing data, in other words, combination of image data in a bit map format of three channels of RGB (hereinafter referred to as RGB image data) and data in which other print setting commands such as the kind and size of a printing media are written may be used. In a case where the typical printing data is used, for example, image processing on the RGB image data and conversion of the RGB image data into binary data that can be handled by the printer engine are performed by the printing control unit 106. In addition, information such as the kind and size of a printing media, which is designated by print setting is used to perform processing of determining the amount of ink application, the number of passes, the printing direction, and the conveyance amount of a printing media and loading the determined data together with the binary data onto the printer engine.

The printing unit (printer engine) 107 performs printing on a printing media (for example, a sheet) as a printing target (printing target object) based on printing data loaded by the printing control unit 106. Since the printer 101 of the present embodiment is a printer of the ink jet scheme as described above, the printing unit (printer engine) 107 performs image formation by ink discharge.

An I/F control unit 105 governs interface functions of the printer 101.

An I/F control unit 110 governs interface functions of the PC 102.

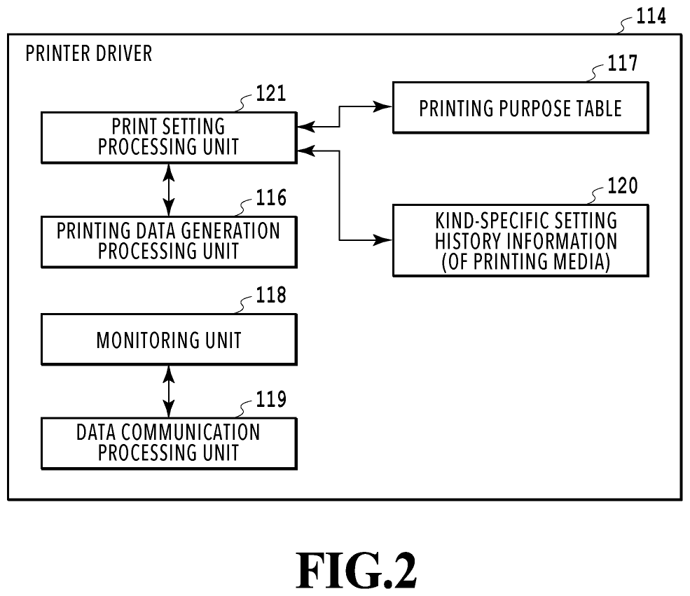

A printer driver 114 is an application program and software for performing various kinds of setting for printing, printing data generation, and printer control on the PC 102. The printer driver 114 will be described later in detail with reference to FIG. 2. Various kinds of processing of the printer driver 114 are executed by a CPU 111. The application program of the printer driver 114 is stored in a non-transitory memory 111b.

A print spooler 115 sequentially stores printing data generated by a printing data generation processing unit 116 (refer to FIG. 2) to be described later. The printing data stored in the print spooler 115 is forwarded to the printer 101. The storage and forwarding of the printing data are performed out of synchronization. Thus, even in a case where printing data generation processing is executed faster than printing processing by the printer 101, the printing data generation processing unit 116 can continuously execute the printing data generation processing without waiting printing processing by the printer 101, which leads to efficient processing. The print spooler is typically provided as a function of the computer operating system.

The CPU 111 is a central control unit including at least one processor and configured to control various kinds of functions of the PC 102. The CPU 111 loads a computer program stored in the non-transitory memory 111b onto a RAM 111a as a work memory and executes the computer program. In addition, the CPU 111 performs display control to display various display targets on a display unit 113. The display control may be performed in cooperation with a non-illustrated graphics processing unit (GPU). An operation unit 112 is an operation device (input device) such as a keyboard, a touch panel, or a mouse and receives various inputs for reflecting a user's intention onto print setting based on an operation on the operation unit 112. A click to be described later is an operation performed with the mouse included in the operation unit 112. The display unit 113 is a display and notifies the user of print setting, warning, and the like through display on the display. Notification by voice output from a speaker or the like can be performed as well as notification through display on the display unit 113.

### <Printer Driver Configuration>

FIG. 2 is a block diagram illustrating a software configuration of the printer driver 114 illustrated in FIG. 1. Processing of each block illustrated in FIG. 2 is executed by the CPU 111 executing the application program as the printer driver 114.

A print setting processing unit 121 is a processing unit configured to perform various kinds of print setting including setting of the kind and size of a printing media to be used and setting of printing quality. The print setting processing unit 121 has functions to display contents that are set based on instructions and inputs from the user, through a GUI displayed on the display unit 113 and notify the user of the contents.

The printing data generation processing unit 116 generates printing data based on print setting that is set by the print setting processing unit 121, and spools the generated printing data to the print spooler 115.

A monitoring unit 118 controls forwarding of the printing data stored in the print spooler 115 based on an instruction from the print spooler 115. More specifically, the printing data stored in the print spooler 115 is sequentially forwarded to the printer 101 through the I/F control unit 110 by a data communication processing unit 119 to be described later, and the monitoring unit 118 controls this forwarding.

The monitoring unit 118 obtains print setting information by analyzing the contents of the printing data before forwarding the printing data to the printer. The monitoring unit 118 also obtains status information such as size information of a printing media, which is set to the printer 101, through bidirectional communication with the printer 101 and controls forwarding of the printing data to the printer 101 based on the obtained status information.

The data communication processing unit 119 performs communication processing with the printer 101 through the I/F control unit 110 in accordance with an instruction from the monitoring unit 118. The communication processing between the data communication processing unit 119 and the printer 101 has bidirectional properties.

The bidirectional communication processing includes processing of forwarding data such as the printing data to the printer 101 and processing of obtaining, from the printer 101, printer status information such as information related to the size of a printing media, information related to the progress of printing processing, and information related to the remaining amount of ink.

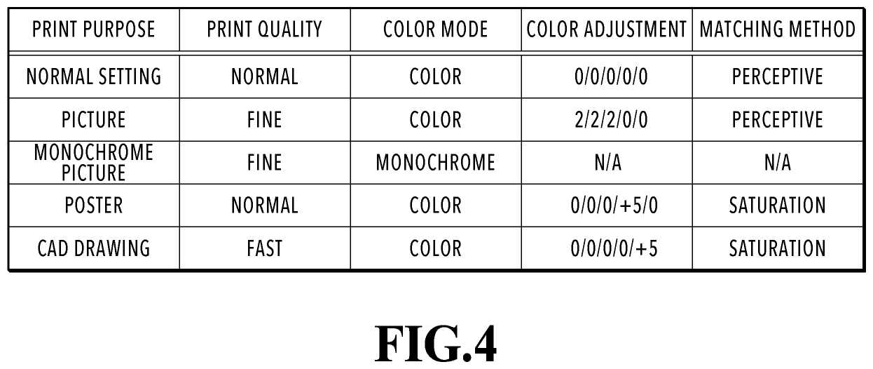

A print purpose table 117 is a table for holding a list of a print purpose option as one of print setting items that are set at the print setting processing unit 121 and the setting content of each option. The print purpose table 117 is stored in the non-transitory memory 111b in the present embodiment but may be stored in, for example, a server on the Internet. Details thereof will be described later with reference to FIG. 4.

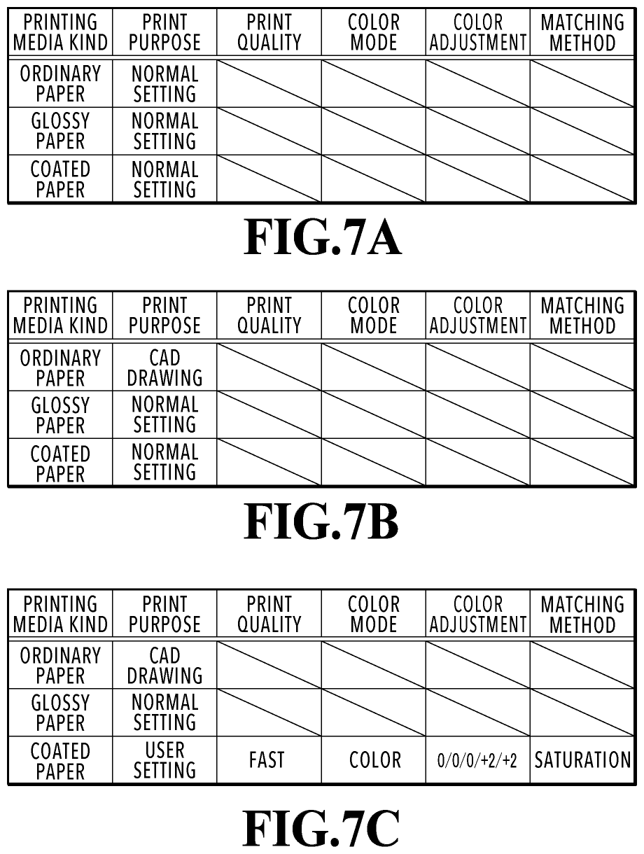

Kind-specific setting history information 120 of a printing media means a table in which print purpose information (parameter value) that is set as a content of specific print setting by the print setting processing unit 121 is held as history information for each kind of printing media. The kind-specific setting history information 120 is stored in the non-transitory memory 111b in the present embodiment but may be stored in, for example, a server on the Internet. Details thereof will be described later with reference to FIGS. 7A to 7C.

In a case where warning display is performed by the information processing apparatus, the warning display is displayed on the display unit 113. For example, in a case where an error occurs at the printer 101 and its error information is to be displayed, the error information of the printer 101 is obtained by the data communication processing unit 119 and displayed on the display unit 113 by the monitoring unit 118. In a case where it is determined that printing is impossible for a reason such as incompatibility of print setting at printing data generation and warning information thereof is to be displayed, the warning information is displayed on the display unit 113 by the printing data generation processing unit 116.

### <Display Content of Print Setting Dialog>

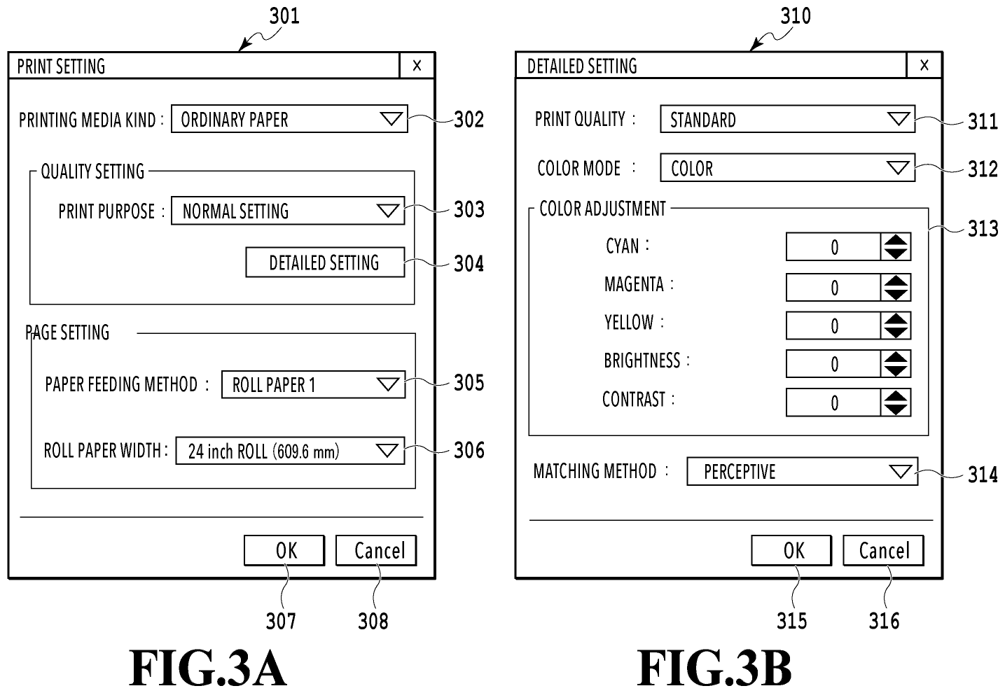

FIGS. 3A and 3B are each a diagram illustrating an example of a dialog box displayed on the display unit 113 of the information processing apparatus 102 illustrated in FIG. 1 and are each a dialog box as a print setting screen displayed when print setting is performed according to the present embodiment.

The print setting dialog boxes illustrated in FIGS. 3A and 3B are GUIs of the printer driver 114 corresponding to the printer 101. Each print setting dialog box is a dialog box displayed before the user performs a printing operation through a software application or the like and is a dialog box for performing print setting related to printing data generation, such as a printing media, a feeding method, and a printing quality.

A print setting dialog box 301 illustrated in FIG. 3A is a dialog box for performing various kinds of print setting. A pull-down list 302 is a control for the user to selectively set the kind of a printing media (non-printed material) set to a feeding unit. In the following description, a printing media as a non-printed material is also simply referred to as a “sheet” for sake of convenience. However, the printing target object is sometimes a material other than paper, such as fabric, plastic, a vinyl sheet, or a label surface of a compact disk (CD), and thus a “sheet” includes these printing medium other than paper. “Ordinary paper”, “glossy paper”, and “coated paper” are prepared as options when the user clicks a downward triangle mark of the pull-down list 302. In the present specification, a control means a display element that receives a user operation or displays information on an operation screen (GUI) of the information processing apparatus. A control that receives a user operation may be referred to as an operation item or an operation icon.

A pull-down list 303 is a control for the user to selectively set a print purpose. “Normal setting”, “picture”, “monochrome picture”, “poster”, and “CAD drawing” are prepared as options when the user clicks a downward triangle mark of the pull-down list 303. The option “normal setting” is set as an initial value when the print setting dialog box 301 is first displayed with no printing history. A print purpose according to the present embodiment enables collective setting of a set of parameters corresponding to a print setting item related to printing quality, and the user can set a print purpose through the pull-down list 303. The pull-down list 303 may be invalidated and receive no user operation until the print setting dialog box 301 is displayed, the printer 101 obtains sheet information through communication with the information processing apparatus 102, and contents based on the sheet information are reflected. In this case, the pull-down lists 302, 305, and 306 may be activated or invalidated.

FIG. 4 is a table listing the contents of a parameter set of print setting items (printing quality, color mode, color adjustment, and matching method) related to printing quality and associated with options that can be selected through the pull-down list 303. Such a table is held as the print purpose table 117 (FIG. 2) in the non-transitory memory 111b.

These print setting items associated with options of the pull-down list 303 are the same as print setting items that can be set through a detailed setting dialog box displayed on the display unit 113 in a case where a detailed setting button 304 is pressed down. FIG. 3B illustrates a detailed setting dialog box 310 as an example of the detailed setting dialog box.

In a case where the user performs only an operation to set a print purpose by using the pull-down list 303 for each individual print setting item that is set through the detailed setting dialog box 310, a parameter set associated with the set option is automatically selected. Contents actually set in this case are based on contents (refer to FIG. 4) held in the print purpose table 117 included in the printer driver 114.

Print setting items that are set through the detailed setting dialog box 310 will be described below.

A pull-down list 311 is a control for the user to selectively set printing quality. “Standard”, “fast”, and “fine” are prepared as options when the user clicks a downward triangle mark of the pull-down list 311.

A pull-down list 312 is a control for setting whether to convert a printing document into monochrome color and print the printing document. “Color” and “monochrome” are prepared as options when the user clicks a downward triangle mark of the pull-down list 312.

A color adjustment region 313 is a region in which controls for adjusting color tone at printing are disposed. As illustrated, controls for adjusting the items of “cyan”, “magenta”, “yellow”, “brightness”, and “contrast” are disposed, and one value in the range of −30 to +30 can be set to the adjustment value of each item. The adjustment value of each item has an initial value of “0”.

A pull-down list 314 is a control for setting a matching method (color correction method) at printing. “Perceptive” and “saturation” are prepared as options when the user clicks a downward triangle mark of the pull-down list 314.

An OK button 315 and a cancel button 316 are controls for designating whether to confirm contents changed through the detailed setting dialog box 310. Specifically, the OK button 315 is pressed down to confirm the contents changed through the detailed setting dialog box 310, and the cancel button 316 is pressed down to discard the changed contents. When the OK button 315 or the cancel button 316 is pressed down, the detailed setting dialog box 310 is closed and the print setting dialog box 301 is displayed as active.

The print setting dialog box 301 will be further described. A pull-down list 305 is a control for selectively setting from which feeding unit sheets are to be fed among the plurality of feeding units included in the printer 101. In the present example, the printer 101 includes two feeding units, and “roll paper 1” and “roll paper 2” are prepared as options when the user clicks a downward triangle mark of the pull-down list 305. The roll paper 1 corresponds to a first feeding unit, and the roll paper 2 corresponds to a second feeding unit.

A pull-down list 306 is a control for selectively setting the width of roll paper that is set at the feeding unit that is set through the pull-down list 305. Paper widths such as “24-inch roll (609.6 mm)” and “A1/A2 roll (594.0 mm)” corresponding to roll paper that can be set to the printer 101 are prepared as options when the user clicks a downward triangle mark of the pull-down list 306.

An OK button 307 and a cancel button 308 are controls for designating whether to confirm contents changed through the print setting dialog box 301. Specifically, the OK button 307 is pressed down to confirm the contents changed through the print setting dialog box 301, and the cancel button 308 is pressed down to discard the changed contents.

### <Print Setting Processing>

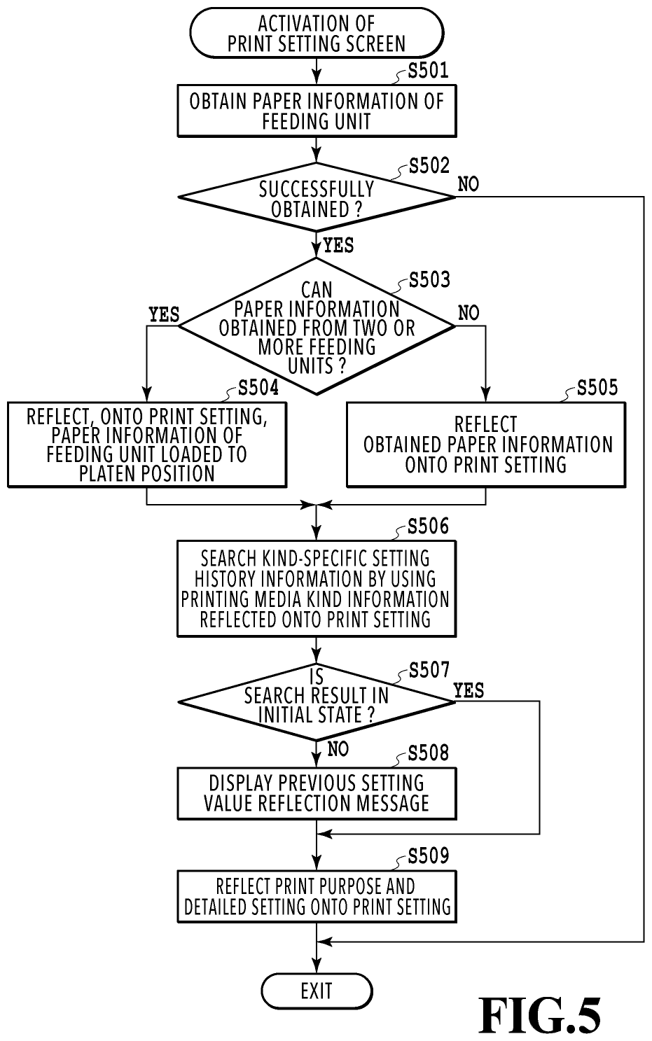

Operation of the printer driver 114 according to the present embodiment will be described below with reference to FIG. 5. The processing in FIG. 5 is implemented as a computer program included in the package of the application program (printer driver 114) stored in the non-transitory memory 111b is loaded onto the RAM 111a and executed by the CPU 111.

Processing of the flowchart in FIG. 5 is started when the user provides an instruction to activate the print setting dialog box 301 (that is, an instruction to display a screen of the print setting dialog box 301). Specifically, the processing is triggered by, for example, press of a button (for example, an activation button for displaying the print setting dialog box 301) included in a GUI of a software application or the like when the user provides a printing instruction to the printer by using the software application. For example, a printing check screen of an application A (for example, an image browser) as a software application that displays a printing target (for example, an image A) is displayed when printing of the image A is instructed while the image A is displayed by the application A. When a button such as a “printer property” button for displaying details of print setting is pressed down on the printing check screen, the processing in FIG. 5 is started and the print setting dialog box 301 is displayed. Upon an instruction to confirm contents set to the print setting dialog box 301 displayed in the processing in FIG. 5, the print setting dialog box 301 is closed and the printing check screen of the application A is displayed again. When a print button is pressed down on the printing check screen of the application A, a printing job of the image A onto which the contents set (displayed) on the print setting dialog box 301 are reflected is transmitted to the printer 101 and printing is executed. No user instruction to use a past history at printing of the image A is provided in the series of operations until the print setting dialog box 301 is displayed. In other words, the processing in FIG. 5 is performed based on a normal operation for printing an image file A in the embodiment. The application A is a software application that is different from the above-described application program including the printer driver 114 in its package. Even in a case where the image A is never printed in the past, the processing in FIG. 5 is started when a button for displaying details of print setting on the printing check screen of the application A, which is displayed in accordance with a printing instruction for the image A is pressed down. In other words, the processing in FIG. 5 is performed even in a case where the printing target is a new printing target that is never printed in the past.

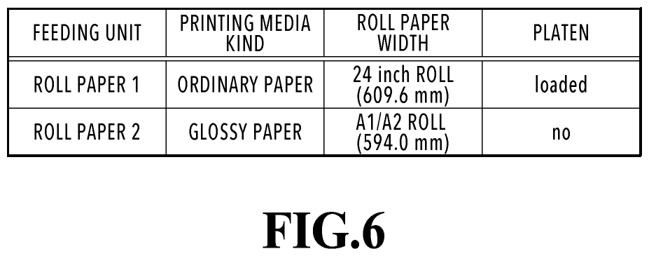

At step S501, the CPU 111 obtains information (referred to as sheet information) indicating which printing media is set to a feeding unit of the printer 101. The sheet information is type information indicating the type of the printing media set to the feeding unit. At the present step, the sheet information stored in the feeding-unit sheet information storage unit 104 of the printer 101 is obtained through the I/F 100 by the print setting processing unit 121 included in the printer driver 114. FIG. 6 illustrates an example of the sheet information obtained at the present step. The sheet information includes, for each feeding unit (the roll paper 1 or the roll paper 2), information (parameter values) of the kind of a set printing media (such as ordinary paper or glossy paper), a roll paper width, and whether the set printing media is moved to a platen position of the printer. Hereinafter, for simplification, “step S” is abbreviated as “S”.

At S502, the CPU 111 determines whether the sheet information (information set exemplarily illustrated in FIG. 6) is obtained at S501. The process proceeds to S503 in a case where a result of the determination at the present step is true, or the series of processes ends in a case where the determination result is false. Various factors of failure to obtain the sheet information include power-off of the printer 101 and failure of communication between the information processing apparatus 102 and the printer 101, but are not particularly limited.

In a case where no printing media is set to the printer 101 and thus no information related to a fed printing media is included in the sheet information obtained at S501, as well, it is regarded that the sheet information cannot be obtained at S502 (NO at S502). When the series of processes illustrated in FIG. 5 ends, the print setting dialog box 301 based on the contents of print setting at that time is displayed on the display unit 113.

At S503, the CPU 111 determines whether printing medium are set to two or more feeding units based on the sheet information obtained at S501. The process proceeds to S504 in a case where a result of the determination at the present step is true, or the process proceeds to S505 in a case where the determination result is false.

S503 will be specifically described below. For example, a case printing medium are set to both the first and second feeding units included in the printer 101 of the present embodiment is discussed. In this case, the sheet information obtained at S501 includes both information including “printing media kind” corresponding to “roll paper 1” and information including “printing media kind” corresponding to “roll paper 2”. In such a case, the determination at S503 obtains “Yes” and the process proceeds to S504.

A case in which a printing media is set to the first feeding unit but no printing media is set to the second feeding unit is discussed. In this case, the sheet information obtained at S501 includes information including “printing media kind” corresponding to “roll paper 1” but does not include information corresponding to “roll paper 2”. Thus, it is understood from the sheet information that no printing media is set to the second feeding unit. In such a case, the determination at S503 obtains “NO” and the process proceeds to S505.

At S504, the CPU 111 checks the sheet information obtained at S501 and reflects, onto print setting, the sheet information of a feeding unit loaded to the platen position (feeding unit having a platen value of “loaded”). For example, with the sheet information illustrated in FIG. 6, the feeding unit loaded to the platen position is determined as the first feeding unit corresponding to “roll paper 1” and having a platen value of “loaded”. Thus, processing for displaying the print setting dialog box 301 onto which the contents of the sheet information of “roll paper 1” are reflected is performed at S504. Specifically, “ordinary paper” is reflected onto the pull-down list 302. Accordingly, “ordinary paper” is automatically set to the pull-down list 302. Similarly, “roll paper 1” is reflected onto the pull-down list 305, and “24-inch roll (609.6 mm)” is reflected onto the pull-down list 306. The above description is made on the form in which the sheet information of the feeding unit loaded to the platen position is preferentially used, but the present embodiment is not limited to this form. In another form, for example, a priority rank is applied to each of the plurality of feeding units in advance and each feeding unit is determined in accordance with the priority rank, in other words, the sheet information of a feeding unit having the highest priority rank among feeding units the sheet information of which is obtained is used. In another form, for example, a feeding unit the sheet information of which is preferentially used is set through the printer driver in advance. For example, a feeding unit used when printing is actually performed last in the past (in other words, a feeding unit selected last or a latest selected feeding unit) may be selected as a target the sheet information of which is to be reflected on print setting at S504.

At S505, the CPU 111 checks the sheet information obtained at S501 and reflects, onto print setting, the sheet information (including information of a feeding unit, a printing media kind, a roll paper width, and a platen as illustrated in FIG. 6) of a feeding unit to which a printing media is set. Specifically, processing for displaying the print setting dialog box 301 onto which the contents of the sheet information of a feeding unit to which a printing media is set are reflected is performed at the present step. Through the present step, reflection is performed onto the pull-down lists 302, 305, and 306 to change the display contents of each pull-down list.

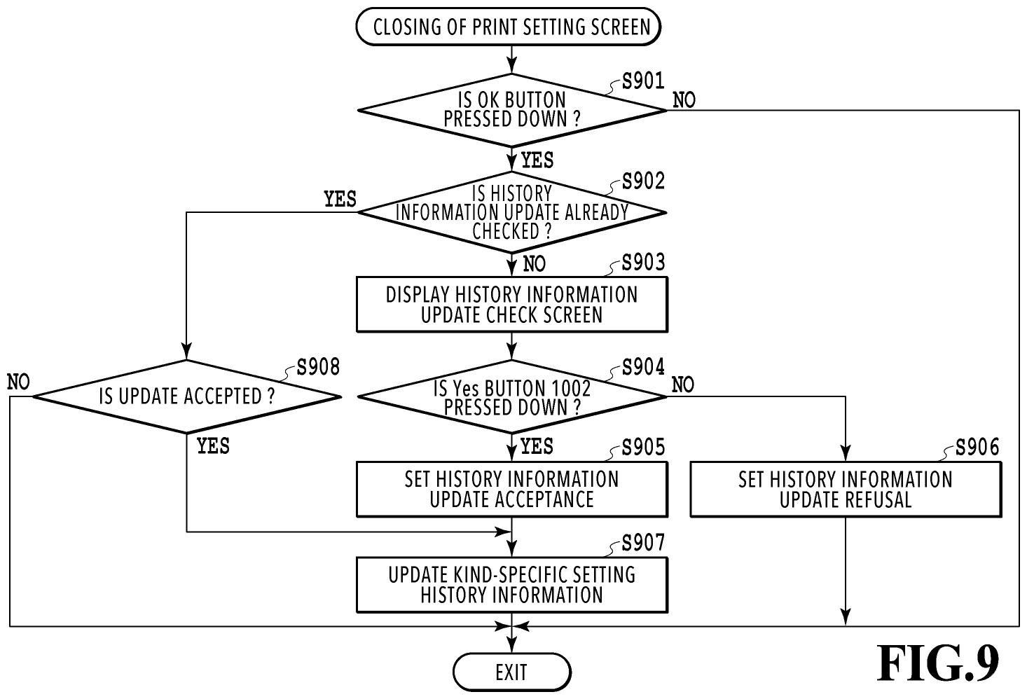

At S506, the CPU 111 searches the kind-specific setting history information 120 by using information (value) of a printing media kind reflected onto print setting at S504 or S505. FIGS. 7A to 7C each illustrate a table in which specific contents are written as an example of the kind-specific setting history information 120. The kind-specific setting history information 120 is a table in which the parameter value of a print purpose designated for print setting by the print setting processing unit 121, specifically, a print setting option that is set through the pull-down list 303 is held as history information for each kind of a printing media as a printing target object. Among FIGS. 7A to 7C, FIG. 7A illustrates the initial state of the kind-specific setting history information 120 according to the present embodiment, and “normal setting”, which is the initial value of the print purpose is written for all kinds of printing medium that can be set to the printer 101. Information written in the kind-specific setting history information 120 is updated when the user closes the print setting dialog box 301. Processing executed when the print setting dialog box 301 is closed will be described later with reference to FIG. 9. In a case where setting of the type of printing media is changed by the user through the pull-down list 302 in the print setting dialog box 301, the processing at S506 and later is performed again in accordance with the changed type of printing media. Thus, with a printing media type that is set by the user, as well, the history information search at S506 to be described later is performed and setting of the print purpose and detailed setting is changed at S509.

At S507, the CPU 111 determines whether information extracted as a result of the search performed at S506 is the initial state of “normal setting”. The process proceeds to S509 in the case of the initial state (in the case of the normal setting), or the process proceeds to S508 otherwise.

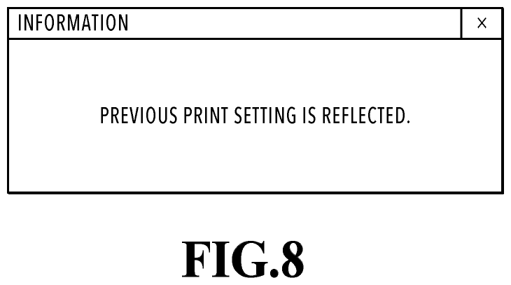

At S508, the CPU 111 displays a message (hereinafter referred to as a previous setting value reflection message) indicating reflection of a previous setting value. FIG. 8 illustrates a display example of the previous setting value reflection message. During display of the previous setting value reflection message, the print setting dialog box 301 is displayed as inactive and does not receive an operation on the print setting dialog box 301. In a case where the information extracted as a result of the search performed at S506 is not the initial state of “normal setting”, setting is automatically performed by using setting contents that are previously set by the user. When notified thereof by the previous setting value reflection message, the user can recognize that an “easy print setting” function to be described later is operating. Moreover, it is possible to prevent confusion of the user due to difference of setting contents displayed in the print setting dialog box 301 from the contents of the normal setting. In addition, the user can reliably recognize that setting is different from the normal setting (default setting), and can be prevented from false recognition of setting contents.

At S509, the CPU 111 sets a print purpose such as reflection onto the pull-down list 303 by using the contents of the kind-specific setting history information 120.

For example, in a case where “ordinary paper” is reflected onto the pull-down list 302 at S504 or S505, the kind-specific setting history information is searched with “ordinary paper” at S506. Then, in a case where the kind-specific setting history information 120 at that time is that illustrated in FIG. 7B, “CAD drawing” is extracted as information of a print purpose corresponding to the printing media kind “ordinary paper” from the kind-specific setting history information 120.

As described above, FIG. 8 illustrates a display example of a dialog box of the previous setting value reflection message, and in the present example, the dialog box of the previous setting value reflection message does not have a button for closing the dialog box and automatically closes after display for a certain time. The dialog box of the previous setting value reflection message may be provided with a button for closing the dialog box so that the user closes the dialog box of the previous setting value reflection message by pressing down the button at an optional timing. When the dialog box of the previous setting value reflection message is closed, the print setting dialog box 301 returns to the state of being displayed as active.

Thereafter at S509, the extracted “CAD drawing” is initially set to the pull-down list 303 and displayed. The “CAD drawing” is a setting content based on a setting history used by the user for past printing and is a print purpose that is set in a case where the printing media kind is “ordinary paper” at the past printing. The “CAD drawing” is a print purpose (latest history) that is set last for “ordinary paper”. In this manner, contents based on history information are automatically initially set to the pull-down list 303 (one of setting items) and displayed even when no user operation that instructs use of a past history for a current printing target (for example, the above-described image file A) is provided. As described above, the “CAD drawing” is changeable to other setting through selection from among setting value candidates displayed when the user clicks the downward triangle mark of the pull-down list 303.

For example, in a case where “glossy paper” is reflected onto the pull-down list 302 at S504 or S505, the kind-specific setting history information is searched with “glossy paper” at S506. Then, in a case where the kind-specific setting history information 120 at that time is that illustrated in FIG. 7B, “normal setting” is extracted as information of a print purpose corresponding to the printing media kind “glossy paper” from the kind-specific setting history information 120. Thereafter at S507, the CPU 111 determines whether the extracted information of the print purpose is the initial state of “normal setting”, and in the present case, no message display (S508) is performed since the information is the initial state of “normal setting”. At the following S509, the extracted “normal setting” is initially set to the pull-down list 303 and displayed. As described above, the “normal setting” is changeable to other setting through selection from among setting value candidates displayed when the user clicks the downward triangle mark of the pull-down list 303.

After S507, the print setting dialog box 301 based on the contents of print setting at that time is displayed on the display unit 113 as described above.

The processing executed when the print setting dialog box 301 is closed will be described below with reference to FIG. 9. FIG. 9 is a flowchart of the processing executed when the print setting dialog box 301 is closed.

At S901, the CPU 111 determines whether the OK button 307 of the print setting dialog box 301 is pressed down. Press-down of the OK button 307 is an instruction operation that completes setting change using the print setting dialog box 301. Press-down of the OK button 307 is also an instruction operation that confirms contents that are set through the print setting dialog box 301, and an instruction operation that closes a screen for setting change. The process proceeds to S902 in a case where a result of the determination at the present step is true. The series of processes ends in a case where the result of the determination at the present step is false (that is, in a case where the cancel button 308 is pressed down).

The case of YES at S901 means that contents currently set in the print setting dialog box 301 (that is, contents being displayed) are confirmed for print setting.

At S902, the CPU 111 refers to a history information update check result (value set at S905 or S906 to be described later) stored in the non-transitory memory 111b and determines whether history information update is already checked. The history information update check result (value set at S905 or S906 to be described later) used at the present step is information indicating that a selection operation has been made in a message dialog box 1001 to be described later. In a case where no history information update check result is stored in the non-transitory memory 111b, it is determined that history information update is not already checked, and the process proceeds to S903. Specifically, in a case where the OK button 307 of the print setting dialog box 301 is pressed down for the first time (in a case where no selection has been made through the message dialog box 1001), it is determined that history information update is not already checked at S902, and the process proceeds to S903. In a case where the history information update check result is stored in the non-transitory memory 111b, the process proceeds to S908 without displaying the message dialog box 1001. The case where the history information update check result is stored in the non-transitory memory 111b is a case where history information update is already checked, specifically, a case where information indicating that a selection operation has been made through the message dialog box 1001 is stored.

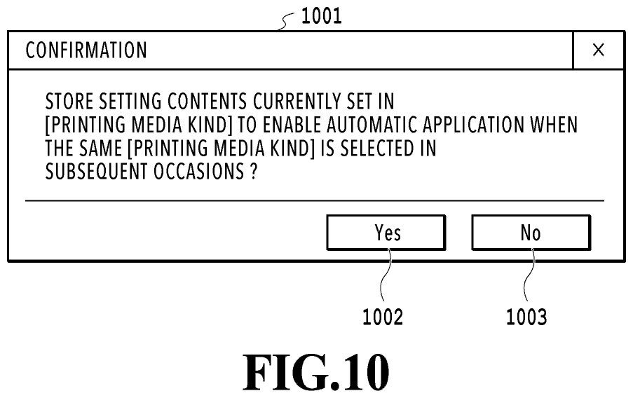

At S903, the CPU 111 displays a message dialog box for checking to the user whether currently set contents are to be stored as a history. FIG. 10 illustrates an example of the message dialog box displayed at the present step. In FIG. 10, the check message, a Yes button 1002, and a No button 1003 are displayed in the message dialog box 1001, and the message dialog box 1001 is closed when any of the two buttons is pressed down. A message “store setting contents currently set in [printing media kind] to enable automatic application when the same [printing media kind] is selected in subsequent occasions?” is displayed as the check message. In this manner, the check message is a message for checking to the user whether to perform automatic print setting based on a past setting history of the user in accordance with a sheet type.

At S904, the CPU 111 determines whether the Yes button 1002 of the message dialog box 1001 is pressed down. The process proceeds to S905 in a case where the Yes button 1002 is pressed down, or the process proceeds to S906 otherwise.

At S905, the CPU 111 stores information indicating acceptance of history information update in the non-transitory memory 111b. Specifically, a function (referred to as “easy print setting”) to perform automatic print setting based on a past setting history of the user in accordance with a sheet type is set to effective.

At S906, the CPU 111 stores information indicating refusal of history information update in the non-transitory memory 111b and ends processing. Specifically, the function “easy print setting” is set to ineffective.

At S907, the CPU 111 updates the kind-specific setting history information 120 by using the value of a printing media kind (the pull-down list 302) and the value of a print purpose (the pull-down list 303) that are currently set in the print setting dialog box 301. Specifically, among setting values written in the kind-specific setting history information 120, the setting values of print setting (print purpose, printing quality, color mode, or the like) related to the kind of a printing media that is set in the print setting dialog box 301 are updated to currently set contents. The currently set contents (current setting contents) are print setting changed when a setting change operation through the print setting dialog box 301 is performed on setting values (in other words, setting values set by “easy print setting”) automatically set through the processing in FIG. 5.

At S908, the CPU 111 determines whether history information update stored in the non-transitory memory 111b indicates acceptance. In a case where update acceptance (in other words, the easy print setting is effective) is determined, the process proceeds to S907. In a case where update refusal (in other words, the easy print setting is ineffective) is determined, the processing in FIG. 9 ends without performing the processing at S907. In this manner, processing of updating the kind-specific setting history information 120 by using current setting contents is not performed in a case where the easy print setting is ineffective.

For example, the user activates the print setting dialog box 301 for the first time, sets “ordinary paper” through the pull-down list 302 and “CAD drawing” through the pull-down list 303 in the print setting dialog box 301, and presses down the OK button 307. In a case where the Yes button 1002 is pressed down in a history information update check message dialog box 1001 displayed thereafter, the kind-specific setting history information 120 is updated from the state illustrated in FIG. 7A to the state illustrated in FIG. 7B. In a case where the print setting dialog box 301 is activated and the OK button 307 is pressed down again, the history information update check message dialog box 1001 is not displayed and the kind-specific setting history information 120 is updated. In this manner, print setting performed in a case of printing on an actual printing target is used (automatically applied) in subsequent occasions as well without a dedicated operation by the user to intentionally register setting for each sheet in advance (in other words, without an operation such as press-down of a registration button). Thus, according to the present embodiment, work for print setting in accordance with the type of printing media in subsequent occasions is omitted based on a print setting operation for printing a printing target without intentional preparation by the user.

Although the case where the history information update check message dialog box 1001 is displayed only when the OK button 307 of the print setting dialog box 301 is pressed down for the first time is described in the present embodiment, the present invention is not limited to the case. For example, the history information update check message dialog box 1001 may be displayed each time the OK button 307 is pressed down, and operation may be performed in accordance with press-down of the Yes button 1002 or the No button 1003.

In this manner, according to the present embodiment, a print purpose (and corresponding printing parameters) lastly set for the type of a set printing media is obtained from history information in accordance with the type of the set printing media and is initially set and displayed. Accordingly, a print purpose lastly used for a set sheet (printing media) is set without performing an operation to select a print purpose each time by the user, and thus work for print purpose setting can be omitted.

In other words, according to the present embodiment, in a case where the type of a printing media that is set as a printing target medium is a first type, first information indicating first print setting based on the setting history of the user is displayed as a content to be set to a print purpose as one of setting items. In a case where the type of printing media that is set as a printing target medium is a second type, second information indicating second print setting based on the setting history of the user is displayed as a content to be set to a print purpose as one of setting items. The first type is, for example, “ordinary paper” and the first information is, for example, “CAD drawing”. The second type is, for example, “glossy paper” and the second information is, for example, “normal setting”.

Although the example in which the kind-specific setting history information 120 is updated with contents that are set at a time point when the OK button 307 of the print setting dialog box 301 is pressed down is described in the present embodiment, the present invention is not limited thereto. For example, in accordance with instruction of printing execution by the user (in other words, after an instruction of printing execution is made), the kind-specific setting history information 120 may be updated with setting contents used in the printing execution. Moreover, in accordance with instruction of printing execution by the user and storage of printing data in the print spooler 115 based on the instruction, the kind-specific setting history information 120 may be updated with setting contents used in the printing execution. Alternatively, in accordance with instruction of printing execution by the user and forwarding of stored printing data from the print spooler 115 to the printer 101, the kind-specific setting history information 120 may be updated with setting contents used in the printing execution.

Although the example in which one latest setting content (lastly set setting content) is stored as the kind-specific setting history information 120 for each kind of printing media is described above, the present invention is not limited thereto. Setting contents for a plurality of times in the past may be stored and a print purpose having the highest use frequency (set frequency) may be initially set and displayed for each kind of printing media. Moreover, a print purpose that is initially set to the pull-down list 303 may be that lastly set for each kind of printing media or having the highest use frequency. Then, the arrangement order of a plurality of setting candidates displayed when the downward triangle mark of the pull-down list 303 is clicked may be changed to descending order of dates and times set in the past or descending order of use frequency in the past, and the setting candidates may be displayed.

<Processing Executed in a Case where Detailed Setting is Performed at Print Setting>

A case where the user opens the detailed setting dialog box 310 by pressing down the detailed setting button 304 in the print setting dialog box 301 and changes detailed setting of print setting through the detailed setting dialog box 310 will be described below.

In this case, the processing illustrated in FIG. 9 is executed when the print setting dialog box 301 is closed upon press-down of the OK button 307 after change and confirmation of detailed setting (press-down of the OK button 315) are performed through the detailed setting dialog box 310.

At S901, the CPU 111 determines whether the OK button 307 of the print setting dialog box 301 is pressed down. The process proceeds to S902 in a case where a result of the determination at the present step is true. The processing in FIG. 9 ends in a case where the result of the determination at the present step is false (specifically, in a case where the cancel button 308 is pressed down instead of the OK button 307).

Processing at S902 and later is the same as above-described operation and thus details thereof is omitted, whereas processing of updating the kind-specific setting history information 120 at S907 will be described below in detail.

At S907, the CPU 111 updates the kind-specific setting history information 120 by using the value of a printing media kind (the pull-down list 302) and the value of a print purpose (the pull-down list 303) that are currently set. The kind-specific setting history information 120 is also updated by using the value of printing quality (the pull-down list 311), the value of a color mode (the pull-down list 312), the value of a pull-down list in the color adjustment region 313, and the value of a matching method (the pull-down list 314).

For example, the user sets “coated paper” through the pull-down list 302. In addition, the user sets “fast” through the pull-down list 311, “color” through the pull-down list 312, “brightness +2” and “contrast +2” in the color adjustment region 313, and “saturation” through the pull-down list 314. In this case, at S907, the kind-specific setting history information 120 is updated, and in the present example, is updated to a content as written in the row of the kind “coated paper” in FIG. 7C. In such a case where the user changes detailed setting instead of using the value of a print purpose that can be initially selected through the pull-down list 303 (refer to FIG. 4), “user setting” is set as the value of the pull-down list 303. In the kind-specific setting history information 120 as well, “user setting” is written as the value of a print purpose as illustrated in FIG. 7C.

Thereafter, the processing illustrated in FIG. 5 is executed again in a case where the closed print setting dialog box 301 is activated (displayed). Processing at S501, S502, and S503 has the same contents as described above. A case where “coated paper” is reflected onto the pull-down list 302 of the print setting dialog box 301 at S504 or S505 is discussed. In this case, at S506, the CPU 111 searches the kind-specific setting history information 120 in FIG. 7C and extracts the print purpose value “user setting” written in the row of “coated paper” and associated values of detailed setting (printing quality, color mode, color adjustment, and matching method). Then at S509, the CPU 111 reflects contents (values) extracted at S506 onto the print setting dialog box 301.

### Effects of the Present Embodiment

According to the present embodiment, print setting in accordance with usage of a printed material desired for each user does not need to be performed each time a printing media that is set to the printer is replaced. Even when a printing media (printing medium) that is set to the printer is changed, setting based on a past history is performed only by operating in a normal printing operation procedure without performing a setting operation in accordance with the set printing media. Thus, an operation through the printer driver is simplified and efficiency improves. Accordingly, usability related to print setting improves.

### Second Embodiment

### <Processing Reflecting Print Setting Based on Printing Media Kind and Size>

In the first embodiment, the kind of printing media in the sheet information (FIG. 6) of a feeding unit of the printer 101 is used as a reference. Specifically, in updating of the kind-specific setting history information 120, the values of a print purpose and detailed setting, which are selectively set by the user are written and held in the kind-specific setting history information 120 (S907 in FIG. 9) for each value of the printing media kind. In addition, reflection (S509 in FIG. 5) from the kind-specific setting history information 120 onto the print setting dialog box 301 is performed for each value of the printing media kind.

However, in the present embodiment, an example in which two of the kind and size (referred to as a roll paper width in the present example) of printing media in the sheet information (FIG. 6) of a feeding unit of the printer 101 are used as references will be described below. In the following, description of the same content as in the first embodiment is omitted as appropriate, and contents different from the first embodiment will be mainly described.

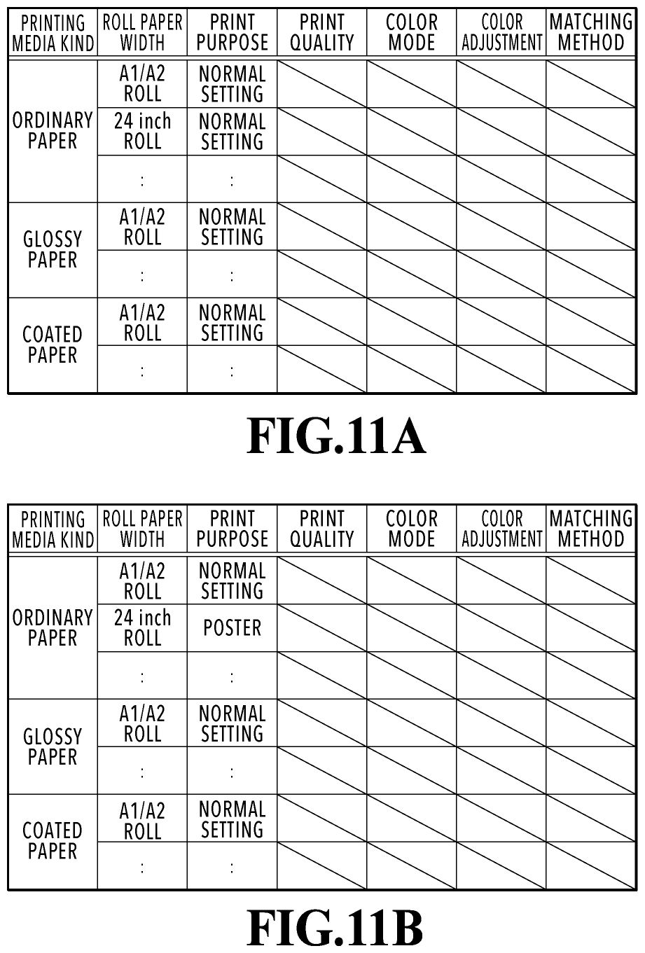

FIGS. 11A and 11B illustrate examples of the kind-specific setting history information 120 in a case where the two values of the kind and size of printing media are used as references. Differences from the first embodiment (refer to FIGS. 7A to 7C) are such that a roll paper width is included as a column, a plurality of values of the roll paper width are set for each value of the printing media kind, and information such as a print purpose is held for each combination of the value of the printing media kind and the value of the roll paper width.

FIG. 11A illustrates the initial state of the kind-specific setting history information 120 according to the present embodiment, and setting history information of a print purpose is written for each value of the printing media kind and each value of the roll paper width. The initial value of “normal setting” is written as the value of a print purpose for each value of the printing media kind and each value of the roll paper width.

Similarly to the first embodiment, the processing illustrated in FIG. 9 is executed when the user closes the print setting dialog box 301. For example, through the print setting dialog box 301, “ordinary paper” is set to the pull-down list 302, “24-inch roll (609.6 mm)” is set to the pull-down list 306, and “poster” is set to the pull-down list 303.

In this case, the content of the kind-specific setting history information 120 is updated as illustrated in FIG. 11B by the processing at S907. Specifically, the value of a print purpose is changed from “normal setting” to “poster”.

Similarly to the first embodiment, the processing illustrated in FIG. 5 is executed in a case where the closed print setting dialog box 301 is activated (displayed). Specifically, at S501, the information illustrated in FIG. 6 is obtained as the sheet information of a feeding unit. Then at S504, for example, “ordinary paper” is reflected onto the pull-down list 302 and “24-inch roll (609.6 mm)” is reflected onto the pull-down list 306. In this case, at S506, the kind-specific setting history information 120 in FIG. 11B is searched by using the values of the printing media kind and the roll paper width, which are reflected at S504 (or S505). Through the search, “poster” as the value of a print purpose is extracted, and as a result, “poster” is reflected onto the pull-down list 303 at S509.

### Third Embodiment

### <Switching of Quality Setting Method Through Setting Mode (Pull-Down List 1202)>

In the first embodiment, various kinds of setting is performed through a print setting dialog box (FIG. 3A), but detailed setting related to printing quality is performed through a dialog box (FIG. 3B) different from FIG. 3A.

However, in the present embodiment, an example in which detailed setting related to printing quality can be performed by switching display without opening another dialog box will be described below. In the following, description of the same content as in the first embodiment is omitted as appropriate, and contents different from the first embodiment will be mainly described.

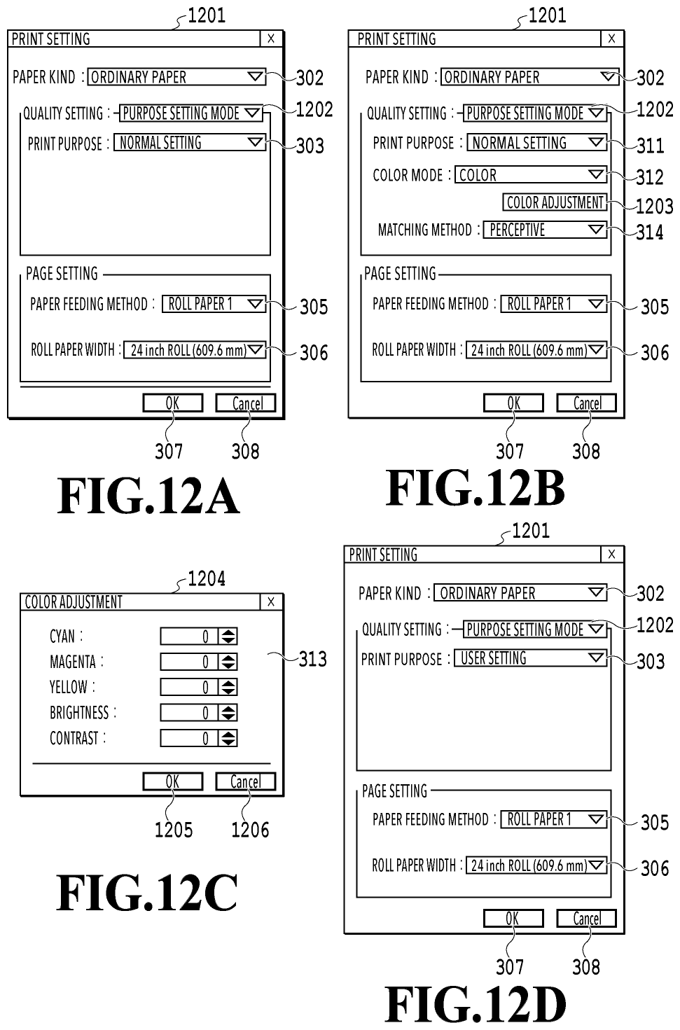

FIGS. 12A to 12D illustrate a print setting dialog box according to the present embodiment. The present embodiment is different from the first embodiment (refer to FIGS. 3A and 3B) in that a print setting dialog box 1201 includes a pull-down list 1202 as a control for switching a quality setting method.

The user can perform detailed setting related to printing quality on the same screen by switching quality setting through the pull-down list 1202. In FIGS. 12A to 12D, any control provided with the same number as in the first embodiment (FIGS. 3A and 3B refer to) in the print setting dialog box 1201 is the same constituent component as in the first embodiment. Detailed description of the constituent component is omitted as appropriate.

The user can select any of “purpose setting mode” and “detailed setting mode” through the pull-down list 1202. The “purpose setting mode” is a mode in which quality setting is performed through a print purpose (the pull-down list 303), and the “detailed setting mode” is a mode in which various kinds of quality setting are individually performed.

FIG. 12A illustrates an example in a case where the “purpose setting mode” is selected through the pull-down list 1202. The print setting dialog box 1201 in this case includes the pull-down list 303 for setting a print purpose. The user can selectively set a print purpose through the pull-down list 303.

In the present embodiment, “purpose setting mode” is selected in the initial state of the pull-down list 1202 when the print setting dialog box 1201 is opened.

FIG. 12B illustrates an example in a case where the “detailed setting mode” is selected through the pull-down list 1202. In this case, the print setting dialog box 1201 includes the pull-down list 311 for setting printing quality, the pull-down list 312 for setting a color mode, and the pull-down list 314 for setting a matching method. The user can individually set various qualities through these pull-down lists.

In a case where the “detailed setting mode” is selected through the pull-down list 1202, the print setting dialog box 1201 includes a color adjustment button 1203 in quality setting. The user can open a color adjustment dialog box 1204 illustrated in FIG. 12C by pressing down the color adjustment button 1203 and can perform various kinds of color adjustment setting in the color adjustment region 313.

The color adjustment dialog box 1204 includes an OK button 1205 and a cancel button 1206, and these buttons are controls for designating whether to confirm a content changed through the color adjustment dialog box 1204. Specifically, the OK button 1205 is pressed down to confirm the content changed through the color adjustment dialog box 1204, and the cancel button 1206 is pressed down to discard the changed content. When the OK button 1205 or the cancel button 1206 is pressed down, the color adjustment dialog box 1204 is closed and the print setting dialog box 1201 is displayed as active.

FIG. 12D illustrates the print setting dialog box in a case where the user selects the “purpose setting mode” through the pull-down list 1202 after changing any quality setting in a state in which the “detailed setting mode” is selected through the pull-down list 1202 in FIG. 12B. In this case, “user setting” is set as the value of the pull-down list 303 as illustrated.

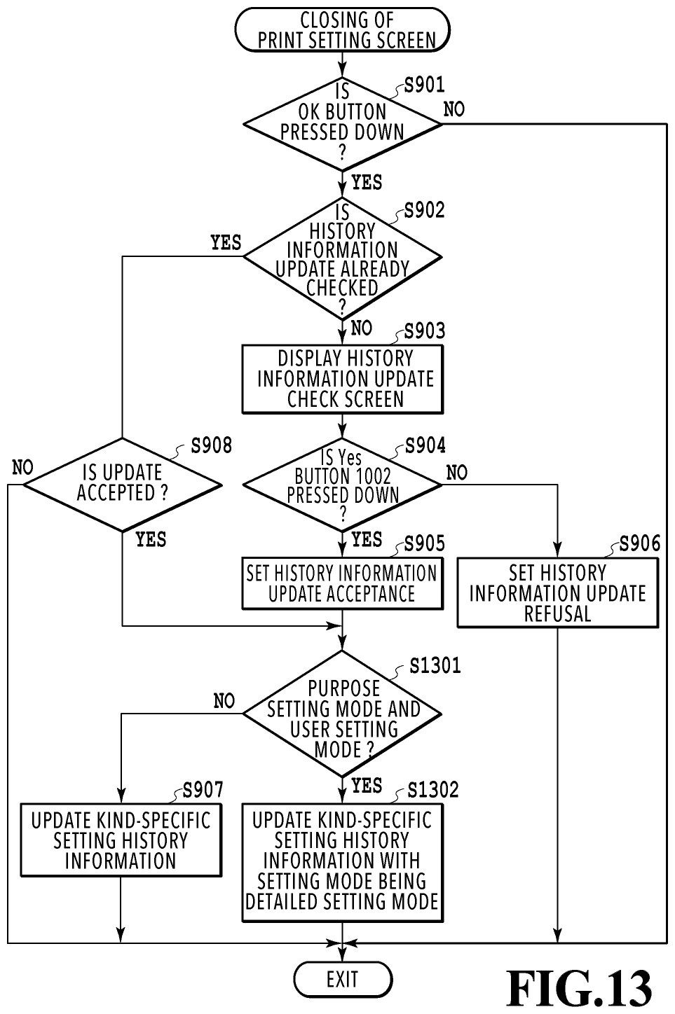

Processing performed when the print setting dialog box 1201 is closed in the present embodiment will be described below with reference to FIG. 13. FIG. 13 is a flowchart of the processing performed when the print setting dialog box 1201 is closed in the present embodiment. In the following description, the same processing as in the first embodiment is denoted by the same number and detailed description thereof is omitted (refer to FIG. 9).

In the present embodiment, processing at S1301 is executed in a case where the OK button 307 in the print setting dialog box 1201 is pressed down (YES at S901) and history information update is accepted (that is, in the case of YES at S904 or YES at S908).

At S1301, the CPU 111 determines whether “purpose setting mode” is selected in the pull-down list 1202 and “user setting” is selected in the pull-down list 303 in the print setting dialog box 1201. The process proceeds to S1302 in a case where a result of the determination at the present step is true, or the process proceeds to S907 in a case where the determination result is false.

At S1302, the CPU 111 updates the kind-specific setting history information 120 by using the value of a sheet kind (the pull-down list 302) and setting values in a case where quality setting is “detailed setting mode”, which are currently set in the print setting dialog box 1201.

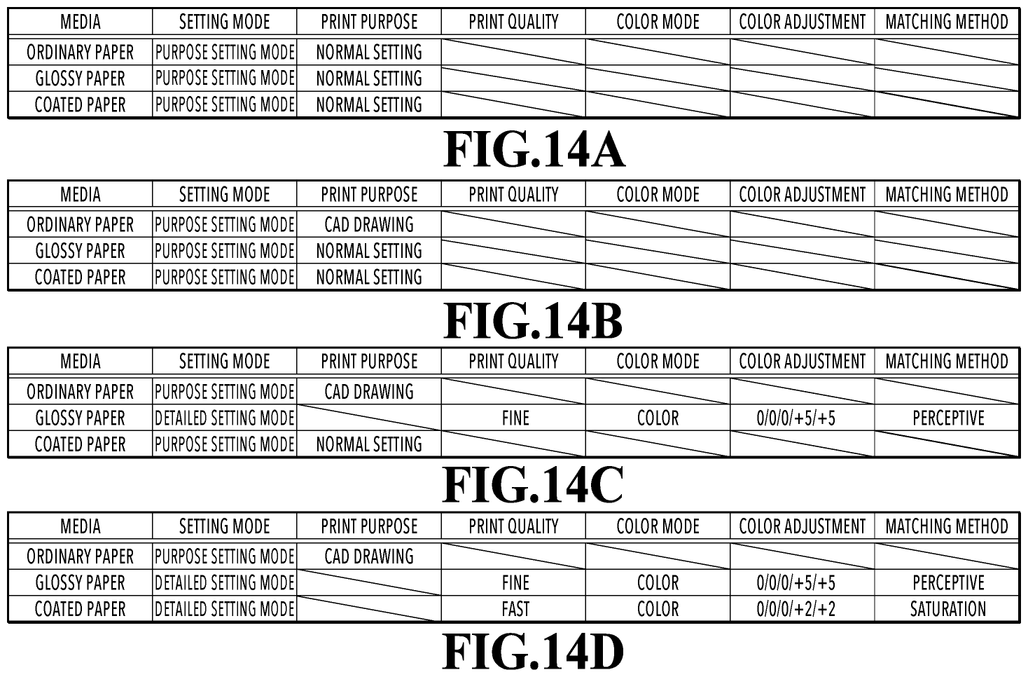

The kind-specific setting history information 120 in the present embodiment will be described below with reference to FIGS. 14A to 14D. FIGS. 14A to 14D each illustrate a table in which specific contents are written as an example of the kind-specific setting history information 120. In the present embodiment, unlike the first embodiment (refer to FIG. 4), the table includes the column of a setting mode in which setting values set through the pull-down list 1202 are written in fields as values of a setting mode.

FIG. 14A illustrates the initial state of the kind-specific setting history information 120 according to the present embodiment, and “purpose setting mode” as the initial value of a setting mode and “normal setting” as the initial value of a print purpose are written for each kind of a printing media that can be set to the printer 101.

FIG. 14B illustrates, as an update example of the kind-specific setting history information 120 illustrated in FIG. 14A, a state in which the kind-specific setting history information 120 is updated in “purpose setting mode”. Specifically, in the state illustrated in FIG. 14A, “ordinary paper” is set through the pull-down list 302, “purpose setting mode” is set through the pull-down list 1202, and “CAD drawing” is set through the pull-down list 303 in the print setting dialog box 1201. Thereafter, the kind-specific setting history information 120 illustrated in FIG. 14B is obtained when the user presses down the OK button 307.

FIG. 14C illustrates, as an update example of the kind-specific setting history information 120 illustrated in FIG. 14B, a state in which the kind-specific setting history information 120 is updated in “detailed setting mode”. Specifically, in the state illustrated in FIG. 14B, “glossy paper” is set through the pull-down list 302, “detailed setting mode” is set through the pull-down list 1202, and “fine” is set through the pull-down list 311 in the print setting dialog box 1201. In addition, “color” is set through the pull-down list 312, “brightness +5” and “contrast +5” are set in the color adjustment region 313, and “perceptive” is set through the pull-down list 314. Thereafter, the kind-specific setting history information 120 illustrated in FIG. 14C is obtained when the user presses down the OK button 307.

FIG. 14D illustrates, as an update example of the kind-specific setting history information 120 illustrated in FIG. 14C, a state in which the kind-specific setting history information 120 is updated after switching to “purpose setting mode”. Specifically, in the state illustrated in FIG. 14C, “coated paper” is set through the pull-down list 302, “detailed setting mode” is set through the pull-down list 1202, and “fast” is set through the pull-down list 311 in the print setting dialog box 1201. In addition, “color” is set through the pull-down list 312, “brightness +2” and “contrast +2” are set in the color adjustment region 313, and “saturation” is set through the pull-down list 314. Thereafter, “purpose setting mode” is set through the pull-down list 1202, and after this setting, the kind-specific setting history information 120 illustrated in FIG. 14D is obtained when the OK button 307 is pressed down. In the print setting dialog box 1201, since the final switching to “purpose setting mode” is made through the pull-down list 1202, “user setting” is set in the pull-down list 303 for a print purpose. However, the setting mode value in data held in the kind-specific setting history information 120 is updated to “detailed setting mode” at S1302.

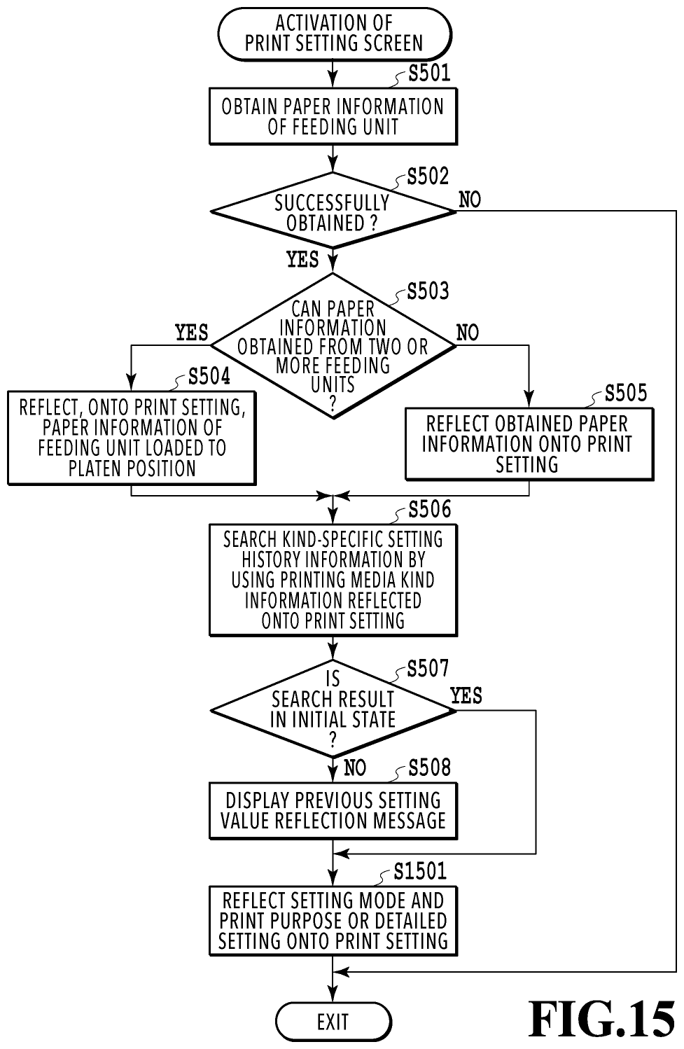

Processing at activation of the print setting dialog box 1201 in the present embodiment will be described below with reference to FIG. 15. FIG. 15 is a flowchart of the processing at activation of the print setting dialog box 1201 in the present embodiment. In the following description, the same processing as in the first embodiment is denoted by the same number and detailed description thereof is omitted (refer to FIG. 5).

In the present embodiment, the CPU 111 searches the kind-specific setting history information 120 illustrated in FIG. 14D at S506 and reflects contents (values) extracted at S506 onto the print setting dialog box 1201 at S1501.

In the following, an example in which “coated paper” is reflected onto the pull-down list 302 in the print setting dialog box 1201 at S504 or S505 is discussed. In this case, at S506, the kind-specific setting history information 120 illustrated in FIG. 14D is searched to extract the setting mode value “detailed setting mode” written in the row of “coated paper” and associated values of detailed setting (printing quality, color mode, color adjustment, and matching method). Then at S1501, the CPU 111 reflects the contents (values) extracted at S506 onto the print setting dialog box 1201.

The above description is made on the method of changing the setting value of a setting mode to “detailed setting mode” in a case where the setting value of a print purpose is “user setting” when the kind-specific setting history information 120 is updated. However, the present embodiment is not limited to the method. For example, when the kind-specific setting history information 120 is updated, the setting value of a print purpose is stored as “user setting” (the setting value of a setting mode as “purpose setting mode”). Then, at next activation of the print setting dialog box, the setting value of a setting mode may be changed to “detailed setting mode” to reflect various kinds of print setting.

In the present embodiment, in a case where the user selects “user setting” as a print purpose in print setting and updates the kind-specific setting history information 120, “detailed setting mode” is automatically selected as quality setting at next activation of the print setting dialog box. Thus, the user can more easily checks details of user setting in print setting, and accordingly, usability related to print setting improves.

### Other Embodiments

The above-described embodiments are also achieved by executing processing as follows. Specifically, in the processing, software (computer program) for achieving functions of the above-described embodiments is supplied to a system or an apparatus through networks or various storage media and is read and executed by a computer (such as CPU or MPU) of the system or the apparatus. The computer program may be executed by one computer or a plurality of computers in a coupled manner. Not the entire above-described processing needs to be implemented by software, but part or the entire of the processing may be implemented by hardware such as an ASIC. Moreover, not the entire processing needs to be performed by one CPU but the processing may be performed by a plurality of CPUs in appropriate cooperation.

Not only functions of the above-described examples are implemented through execution of a program code read by a computer. For example, an OS operating on the computer may perform part or all of actual processing based on an instruction by the program code, and functions of the above-described embodiments may be implemented through the processing.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to improve usability related to print setting.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2023-032749, filed Mar. 3, 2023, No. 2023-156282, filed Sep. 21, 2023, and No. 2023-199024, filed Nov. 24, 2023, which are hereby incorporated by reference wherein in their entirety.

What is claimed is:

1. A non-transitory computer-readable storage medium storing one or more programs configured to cause one or more computers to function as:
an obtaining unit configured to obtain type information indicating the type of a printing media on which printing is to be performed; and
a display controlling unit configured to perform, even when no user instruction to use a past history at printing of a printing target is provided, control to display information as a content to be set to a particular setting item in accordance with the type information obtained by the obtaining unit on a print setting screen displayed based on an operation for printing the printing target, the information indicating print setting based on a setting history including contents of setting by a user at past printing.

2. The storage medium storing the one or more programs according to claim 1, wherein the obtaining unit obtains, as the type information, information related to the type of a printing media that is set to a feeding unit of a printing apparatus.

3. The storage medium storing the one or more programs according to claim 1, wherein the obtaining unit obtains, as the type information, information indicating the type of a printing media that is set to a feeding unit loaded to a platen position in a case where the printing apparatus includes a plurality of feeding units to which printing medium are set.

4. The storage medium storing the one or more programs according to claim 1, wherein the obtaining unit obtains the type information from a printing apparatus.

5. The storage medium storing the one or more programs according to claim 1, wherein the obtaining unit obtains, as the type information, information indicating the printing media type that is set by the user.

6. The storage medium storing the one or more programs according to claim 1, wherein the display controlling unit
displays, as the content to be set to a particular setting item, first information indicating first print setting based on the setting history of the user in a case where the printing media type indicated by the type information is a first type, and
displays, as the content to be set to a particular setting item, second information indicating second print setting based on the setting history of the user in a case where the printing media type indicated by the type information is a second type.

7. The storage medium storing the one or more programs according to claim 1, wherein the display controlling unit performs control to display, as the content to be set to a particular setting item, information indicating print setting that is lastly set for the printing media type indicated by the type information obtained by the obtaining unit.

8. The storage medium storing the one or more programs according to claim 1, wherein the display controlling unit performs control to display, as the content to be set to a particular setting item, information indicating print setting that is most frequently set for the printing media type indicated by the type information obtained by the obtaining unit.

9. The storage medium storing the one or more programs according to claim 1, wherein the one or more computers are further caused to function as
a receiving unit configured to receive, from the user, an instruction to change print setting that is set to the particular setting item; and
a print controlling unit configured to perform control to print print setting as the setting history in association with the printing media type indicated by the type information obtained by the obtaining unit, the print setting being set based on the instruction received by the receiving unit.

10. The storage medium storing the one or more programs according to claim 9, wherein the display controlling unit
performs control to display a setting screen for performing a setting operation related to printing and for receiving an instruction that is receivable by the receiving unit to change the print setting, the setting screen including the particular setting item, and
performs, upon an instruction operation to confirm a content that is set by using the setting screen, control to display a selection screen for selecting whether print setting that is set based on the instruction received by the receiving unit is to be applied in subsequent occasions for the printing media type indicated by the type information obtained by the obtaining unit.

11. The storage medium storing the one or more programs according to claim 10, wherein the print controlling unit performs control to store the print setting that is set based on the instruction received by the receiving unit in a case where selection to perform the application in subsequent occasions is made on the selection screen and not to store the print setting that is set based on the instruction received by the receiving unit in a case where selection not to perform the application in subsequent occasions is made on the selection screen.

12. The storage medium storing the one or more programs according to claim 10, wherein, upon the instruction operation to confirm, the display controlling unit performs control to display the selection screen in a case where no information indicating that selection has been made on the selection screen is stored and not to display the selection screen in a case where information indicating that selection has been made on the selection screen is stored.

13. The storage medium storing the one or more programs according to claim 9, wherein the one or more computers are further caused to function as a searching unit configured to search the setting history for print setting stored in association with the printing media type indicated by the type information obtained by the obtaining unit.

14. The storage medium storing the one or more programs according to claim 9, wherein the display controlling unit performs control to display candidates for a setting content that is set to the particular setting item based on a user operation, the candidates being arranged based on the setting history in descending order of dates and times that are set in the past for the printing media type indicated by the type information obtained by the obtaining unit or in descending order of use frequency in the past.

15. The storage medium storing the one or more programs according to claim 1, wherein the one or more computers are further caused to function as a setting unit configured to set, to the particular setting item, print setting based on a past setting history of the user in accordance with the type information obtained by the obtaining unit even when no user operation is performed to instruct a content that is set to the particular setting item.

16. The storage medium storing the one or more programs according to claim 1, wherein the particular setting item is a setting item for printing.

17. The storage medium storing the one or more programs according to claim 1, wherein a plurality of candidates that can be set to the particular setting item include at least one of a picture, a monochrome picture, a poster, and a CAD drawing.

18. The storage medium storing the one or more programs according to claim 1, wherein the display controlling unit further performs control to display, information indicating print setting based on a past setting history of the user in accordance with the type information obtained by the obtaining unit, as a content that is set to at least one other setting item different from the particular setting item.

19. The storage medium storing the one or more programs according to claim 18, wherein the other setting item is an item that is can be set based on an operation that instructs detailed setting.

20. The storage medium storing the one or more programs according to claim 18, wherein the other setting item is at least one of an item for setting printing quality, an item for setting whether to convert a printing document into monochrome color and print the printing document, an item for adjusting color tone at printing, and an item for setting a matching method or a color correction method at printing.

21. The storage medium storing the one or more programs according to claim 1, wherein the display controlling unit performs control to display, as the content to be set to a particular setting item, information indicating print setting based on the setting history in accordance with the type information obtained by the obtaining unit and a printing media size.

22. The storage medium storing the one or more programs according to claim 1, wherein in a case where information indicating print setting based on the setting history is displayed as the content to be set to a particular setting item, the display controlling unit performs control to display a notification indicating that the print setting based on the setting history is to be reflected.

23. The storage medium storing the one or more programs according to claim 22, wherein while the notification is displayed, a display item for print setting including the particular setting item is in an inactive state in which no operation is to be received.

24. An information processing apparatus control method comprising:
obtaining type information indicating the type of a printing media on which printing is to be performed; and
performing, even when no user instruction to use a past history at printing of a printing target is provided, control to display information as a content to be set to a particular setting item in accordance with the obtained type information on a print setting screen displayed based on an operation for printing the printing target, the information indicating print setting based on a setting history including contents of setting by a user at past printing.

25. An information processing apparatus comprising at least one memory and at least one processor and/or at least one circuit which function as:
an obtaining unit configured to obtain type information indicating the type of a printing media on which printing is to be performed; and
a display controlling unit configured to perform, even when no user instruction to use a past history at printing of a printing target is provided, control to display information as a content to be set to a particular setting item in accordance with the type information obtained by the obtaining unit on a print setting screen displayed based on an operation for printing the printing target, the information indicating print setting based on a setting history including contents of setting by a user at past printing.
